(19) United States
(12) Patent Application Publication
(10) Pub. No.: US 2014/0368623 A1
(43) Pub. Date: Dec. 18, 2014

(54) DISPLAY APPARATUS PROVIDING MULTI-VIEW MODE AND METHOD FOR CONTROLLING THE SAME

(71) Applicant: SAMSUNG ELECTRONICS CO., LTD., Suwon-si (KR)

(72) Inventors: Je-hwan SEO, Daegu (KR); Geun-sam YANG, Suwon-si (KR); Tae-hyeun HA, Suwon-si (KR)

(73) Assignee: SAMSUNG ELECTRONICS CO., LTD., Suwon-si (KR)

(21) Appl. No.: 14/305,030

(22) Filed: Jun. 16, 2014

(30) Foreign Application Priority Data
Jun. 14, 2013 (KR) 10-2013-0068542

(51) Int. Cl. H04N 13/04

(52) U.S. Cl. CPC H04N 13/0429
USPC 348/54

(57) ABSTRACT

A display apparatus is provided. The display apparatus includes a video processor configured to process a plurality of content and generate a plurality of contents views if a multi-view mode is executed, a display configured to display the plurality of content views, a synchronization signal generator configured to generate a synchronization signal for the plurality of content views, a communicator configured to transmit the synchronization signal, and a controller configured to control the communicator to transmit information on a type of the content provided in the multi-view mode to the at least one glasses device.

### CROSS-REFERENCE TO RELATED APPLICATION

This application claims priority from Korean Patent Application No. 10-2013-0068542, filed on Jun. 14, 2013, in the Korean Intellectual Property Office, the disclosure of which is incorporated herein by reference in its entirety.

### BACKGROUND

1. Field

Apparatuses and methods consistent with exemplary embodiments relate to a display apparatus and a method for controlling the same, and more particularly to a display apparatus providing a multi-view mode and a method for controlling the same.

2. Description of the Related Art

With the development of electronic technology, various types of electronic devices have been developed and spread. In particular, various kinds of display devices, such as a television (TV), a mobile phone, a personal computer (PC), a notebook PC, and a personal digital assistant (PDA), have been widely used even in homes.

As the use of display devices is increased, user needs for more diverse functions have increased. Further, in order to meet such user needs, respective manufacturers have successively developed products having new functions.

A great deal of effort has been put into the development of multi-view display devices. The multi-view display device means a display device that provides a multi-view function to provide a plurality of content views. As use of the multi-view display device is spreads, a plurality of users can respectively view their desired content views without being interfered with by other users, even when using one multi-view display device. According to such a multi-view function, unlike the PIP (Picture In Picture) function in the related art, respective content views have the same size, and thus it is expected that the multi-view function has a high utility as compared with the existing PIP function.

In order for a plurality of users to view their desired content views through the multi-view function, the respective users should wear glasses devices that correspond to the multi-view display device. The glasses device may be classified into a shutter glasses type and a polarization type according to the type of the multi-view display device.

Particularly, in case of the shutter glasses type, the display device may transmit synchronization signals for synchronizing the glasses devices with the display timing of the content views to the respective glasses devices, and thus the glasses devices can control the driving of shutter glasses based on the synchronization signals.

If the display device provides the multi-view function, the driving of the glasses devices may differ according to the type of content provided through the multi-view function. Accordingly, there is a need for schemes for the glasses device to determine what content is being displayed by the display device.

### SUMMARY

The present disclosure has been made to address at least the above problems and/or disadvantages and to provide at least the advantages described below. Accordingly, an aspect of the present disclosure provides a display apparatus and a method for controlling the same, which enable glasses devices to determine the type of content being displayed through the display apparatus.

According to one aspect of the present disclosure, a display apparatus includes a video processor configured to process a plurality of contents and generate a plurality of content views if a multi-view mode is executed; a display configured to display the plurality of content views; a synchronization signal generator configured to generate a synchronization signal for the plurality of content views; a communicator configured to transmit the synchronization signal; and a controller configured to control the communicator to transmit information on a type of the content provided in the multi-view mode to the at least one glasses device.

The information on the type of the content may include information indicating whether the content provided in the multi-view mode is 2D content or 3D content.

The controller may add the information on the type of the content to a packet for transmission of the synchronization signal to transmit the packet to the at least one glasses device.

The controller may add the information on the type of the content to the packet for transmission of the synchronization signal using a reserve region provided in the packet to transmit the packet to the at least one glasses device.

The controller may add the information on the type of the content to the packet for transmission of the synchronization signal using a region provided in the packet and including information related to frame synchronization (frame sync) to transmit the packet to the at least one glasses device.

The controller may add a new field to the packet for transmission of the synchronization signal and transmit the information on the type of the content to the at least one glasses device using the new field.

According to another aspect of the present disclosure, a method for controlling a display device includes, processing a plurality of contents and generating a plurality of content views to display the generated content views if a multi-view mode is executed; and transmitting information on a type of the content provided in the multi-view mode to the at least one glasses device if a communication connection is made between the at least one glasses device and the display apparatus.

The information on the type of the content may include information indicating whether the content provided in the multi-view mode is 2D content or 3D content.

The transmitting may comprise adding the information on the type of the content to a packet for transmission of the synchronization signal to transmit the packet to the at least one glasses device.

The transmitting may comprise adding the information on the type of the content to the packet for transmission of the synchronization signal using a reserve region provided in the packet to transmit the packet to the at least one glasses device.

The transmitting may comprise adding the information on the type of the content to the packet for transmission of the synchronization signal using a region provided in the packet and including information related to frame synchronization to transmit the packet, to the at least one glasses device.

The transmitting may comprise adding a new field to the packet for transmission of the synchronization signal and transmit the information on the type of the content to the at least one glasses device using the new field.

As described above, according to various exemplary embodiments of the present disclosure, the at least one glasses device can determine the type of the content that is provided through the content view synchronized with the at least one glasses device using the information on the type of the content that is received from the display apparatus. Accordingly, the accuracy of the operation of the at least one glasses device can be improved.

According to one aspect of the present disclosure, there is provided a system for providing a multiview mode. The system comprising: a display apparatus; and at least one glasses device. The display apparatus comprises: a video processor configured to process a plurality of contents and generate a plurality of content views if the multi-view mode is executed; a display configured to display the plurality of content views; a synchronization signal generator configured to generate a synchronization signal for the plurality of content views; a communicator configured to transmit the synchronization signal; and a controller configured to control the communicator to transmit information on a type of the content provided in the multi-view mode to the at least one glasses device.

The information on the type of the content may include information indicating whether the content provided in the multi-view mode is 2D content or 3D content.

The controller may add the information on the type of the content to a packet for transmission of the synchronization signal, to transmit the packet to the at least one glasses device.

The controller may add the information on the type of the content to the packet for transmission of the synchronization signal using a reserve region provided in the packet to transmit the packet to the at least one glasses device.

The controller may add the information on the type of the content to the packet for transmission of the synchronization signal using a region provided in the packet and including information related to frame synchronization to transmit the packet to the at least one glasses device.

The controller may add a new field to the packet for transmission of the synchronization signal and transmit the information on the type of the content to the at least one glasses device using the new field.

### BRIEF DESCRIPTION OF THE DRAWINGS

The above and other aspects of the exemplary embodiments will be more apparent from the following detailed description when taken in conjunction with the accompanying drawings, in which:

FIGS. 1 to 3 are views explaining the configuration and operation of a display system according to an exemplary embodiment;

FIG. 4 is a block diagram illustrating the configuration of a display apparatus according to an exemplary embodiment;

FIG. 5 is a diagram explaining an example of a packet that a display apparatus transmits to a glasses device according to an exemplary embodiment;

FIG. 6 is a diagram explaining an example of addition of information on the type of content to a packet for transmission of a synchronization signal according to an exemplary embodiment;

FIG. 7 is a block diagram illustrating the detailed configuration of a display apparatus according to an exemplary embodiment;

FIG. 8 is a block diagram illustrating the configuration of a glasses device according to an exemplary embodiment;

FIG. 9 is a diagram explaining a method for determining the type of content that is displayed through a content view synchronized with a glasses device according to an exemplary embodiment;

FIG. 10 is a block diagram illustrating the detailed configuration of a glasses device according to an exemplary embodiment;

FIG. 11 is a view illustrating an example of an external appearance of a glasses device according to an exemplary embodiment; and

FIG. 12 is a diagram illustrating a method for controlling a display apparatus according to an exemplary embodiment.

### DETAILED DESCRIPTION OF EXEMPLARY EMBODIMENTS

Hereinafter, exemplary embodiments are described in detail with reference to the accompanying drawings.

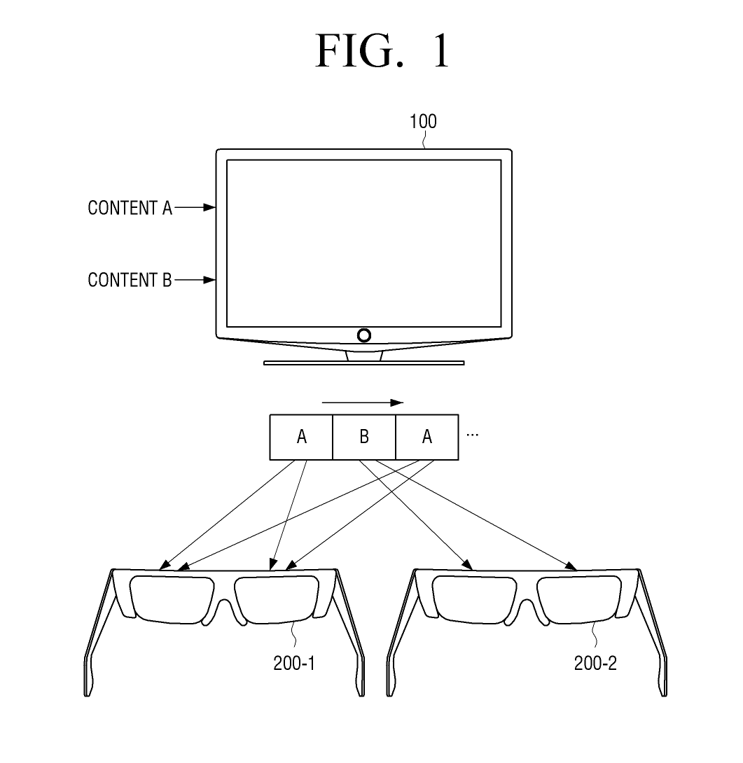

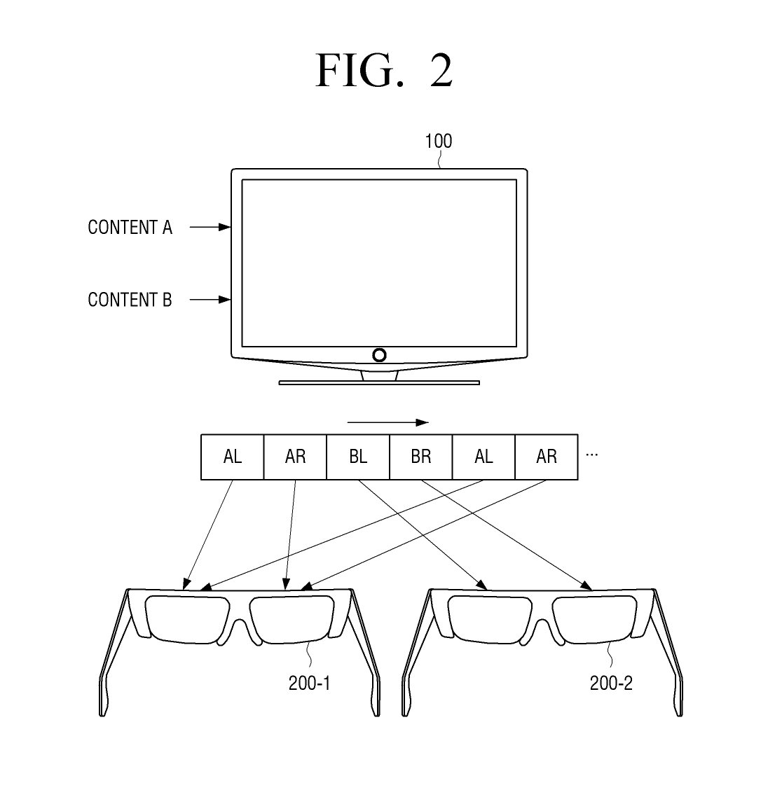

FIGS. 1 to 3 are views explaining the configuration and operation of a display system according to an exemplary embodiment. A display system includes a display apparatus 100 and glasses devices 200-1 and 200-2. Although FIGS. 1 and 2 illustrate that the display apparatus 100 is implemented by a TV, the display apparatus 100 may be implemented by various devices having display units, such as a mobile phone, a PDA, a notebook PC, a monitor, a tablet PC, an electronic book, a digital photo frame, and kiosk.

The display apparatus 100 provides a multi-view function. The multi-view function is a function that provides a plurality of different content using one display apparatus 100. Although a case where two contents are displayed as shown in FIGS. 1 and 2 may be called a dual-view function, it will be commonly called a multi-view function in the description. If a multi-view function is selected, the display apparatus 100 generates a plurality of content views and successively displays the respective content views.

FIG. 1 shows a state where a plurality of content views are constituted using two 2D contents A and B and the constituted contents views are alternately displayed. For convenience in explanation, the respective content views are illustrated as A and B in FIG. 1. Here, the content A and B may be various types of content, such as broadcasting programs received through broadcasting channels, multimedia content provided from a network source, and multimedia content stored in a storage device provided inside or outside the display apparatus 100. Further, the content A and B may not only be moving video content but also content excluding audio, such as still images or text.

The glasses devices 200-1 and 200-2 may be implemented in a shutter glasses type. The shutter glasses type is a type in which a liquid crystal shutter that is provided on a left-eye glass and a liquid crystal shutter that is provided on a right-eye glass are individually turned on or off. That is, the first glasses device 200-1 that matches the content A turns on both the left-eye glass and the right-eye glass to match the output timing of the content view A, and turns off both the left-eye glass and the right-eye glass to match the output timing of the content view B. Accordingly, a user who wears the first glasses device 200-1 can recognize only the content view A.

In contrast, the second glasses device 200-2 that matches the content B turns on the respective glasses to match the output timing of the content view B. Accordingly, a user who wears the second glasses device 200-2 can recognize only the content view B.

The display apparatus 100 transmits a synchronization signal so that the respective glasses devices 200-1 and 200-2 are driven in synchronization with the output timing of the respective content views. The synchronization signal is a signal that makes the display timing of the content views in the display apparatus synchronize with the shutter glasses driving timing of the glasses devices that match the corresponding content view. According to an implementation example, the synchronization signal may be implemented in a form that notifies of the display timing of one content view or may be implemented in a form that includes synchronization information on the whole content views.

The synchronization signal may be transmitted in various ways. For example, the synchronization signal may be transmitted in a form that broadcasts, for example, an IR signal or a radio frequency (RF) signal, or may be transmitted according to various wireless communication protocols, such as Bluetooth, Wi-Fi, ZigBee, and IEEE.

FIG. 2 shows a case where a multi-view function is performed using two 3D contents A and B. The 3D content includes a left-eye image and a right-eye image. Through this, the content A is composed of a left-eye image content view AL and a right-eye image content view AR, and the content B is composed of a left-eye image content view BL and a right-eye image content view BR. Through this, AL, AR, BL, and BR are successively displayed.

The first glasses device 200-1 drives the left-eye glass in synchronization with the output timing of the left-eye image content view AL of the content A, and drives the right-eye glass in synchronization with the output timing of the right-eye image content view AR of the content A. Through this, a user who wears the first glasses device 200-1 can stereoscopically view the 3D content A. In contrast, the second glasses device 200-2 drives the left-eye glass in synchronization with the output timing of the left-eye image content view BL of the content B, and drives the right-eye glass in synchronization with the output timing of the right-eye image content view BR of the content B. Through this, a user who wears the second glasses device 200-2 can stereoscopically view the 3D content B.

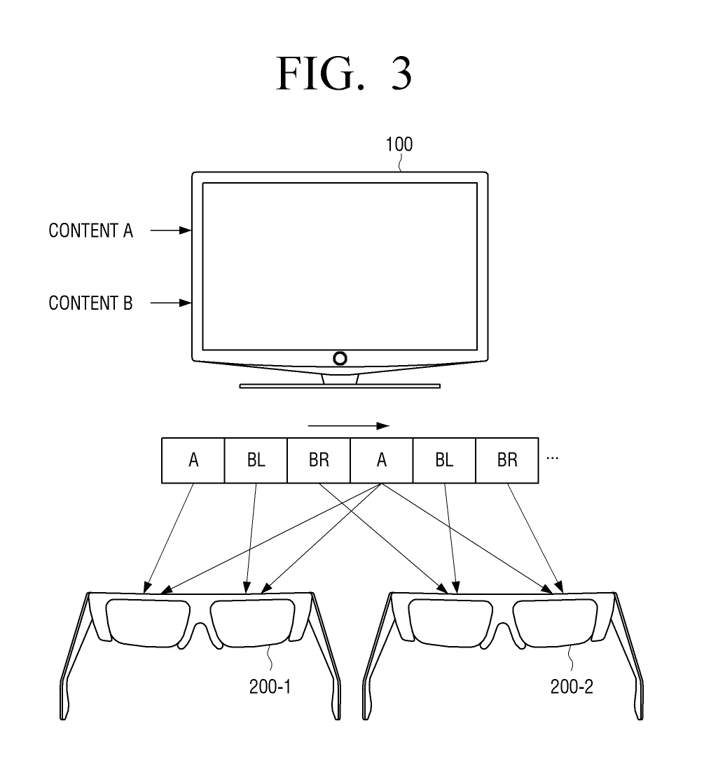

Referring to FIGS. 1 and 2, a method for providing 2D content and 3D content has been described. However, the display system illustrated in FIGS. 1 and 2 may provide 2D content and 3D content to users who wear different glasses devices 200-1 and 200-2. That is, the display apparatus 100 as illustrated in FIG. 3 constitutes the content view A using the content A that is 2D content to display the content view A, and constitutes the content view B through the left-eye image content view BL and the right-eye image content view BR of the content B that is 3D content. Through this, A, BL, and BR are successively displayed.

The first glasses device 200-1 turns on both the left-eye glass and the right-eye glass in synchronization with the output timing of the content view A, and turns on both the left-eye glass and the right-eye glass to match the output timing of the content view B. Through this, the user who wears the first glasses device 200-1 can recognize only the content view A.

In contrast, the second glasses device 200-2 drives the left-eye glass in synchronization with the output timing of the left-eye image content view BL of the content B, and drives the right-eye glass in synchronization with the output timing of the right-eye image content view BR of the content B. Further, the second glasses device 200-2 turns off both the left-eye glass and the right-eye glass in the output timing of the content view A. Through this, the user who wears the second glasses device 200-2 can stereoscopically view the 3D content B.

On the other hand, the display system of FIGS. 1 to 3 may also perform a function of reproducing one piece of 3D content in addition to the multi-view function. In the case of reproducing one 3D content, the respective glasses devices 200-1 and 200-2 alternately drive the left-eye glass and the right-eye glass to match the display timing of the left-eye glass and the right-eye glass. Illustration and explanation of the operation of the display system that reproduces the 3D content will be omitted.

In the display system as described above, if communication is made between the display apparatus 100 and the glasses device, the display apparatus 100 provides the synchronization signal. The respective glasses devices 200-1 and 200-2 may drive respective shutter glass portions using the synchronization signal. Accordingly, among the content views that are currently displayed through the display apparatus 100, the output timing of the respective content views that users of the glasses devices 200-1 and 200-2 intend to view can be synchronized.

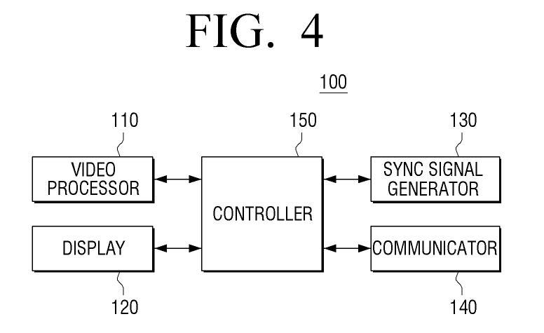

FIG. 4 is a block diagram illustrating the configuration of a display apparatus according to an exemplary embodiment. Referring to FIG. 4, a display apparatus 100 includes a video processor 110, a display 120, a synchronization signal generator 130, a communicator 140, and a controller 150.

If a multi-view mode is executed, the video processor 110 processes a plurality of contents and generates a plurality of content views.

Here, the multi-view mode is a mode in which the display apparatus 100 provides a multi-view function. The controller 150 may control the video processor 110 to generate a plurality of content views if a signal for executing the multi-view mode is received from a remote controller (not illustrated) or glasses devices 200-1 and 200-2 in FIGS. 1 to 3. Further, the controller 150 may provide the multi-view function if a user command for executing the multi-view mode is input through an input means, such as various kinds of buttons provided on the display apparatus 100.

The content may be multimedia content that is provided from various sources, and may include 2D content and 3D content. The content view means a video frame of the content. Content providing sources and the kinds thereof will be described later.

Specifically, the video processor 110 generates a video frame using video data constituting the content. In this case, the video processor 110 processes and generates output data by alternately arranging a video frame generated on the basis of a plurality of contents at least one by one.

For example, the video processor 110 may constitute the output data by alternately arranging the video frames constituting content A that is 2D content and the video frame constituting content B that is 2D content one by one. Further, the video processor 110 may constitute the output data by alternately arranging the video frames constituting content A that is 2D content and left-eye video frames and right-eye video frames constituting content B that is 3D content one by one. Further, the video processor 110 may constitute the output data by alternately arranging left-eye video frames and right-eye video frames constituting content A that is 3D content and left-eye video frames and right-eye video frames constituting content B that is 3D content one by one. As described above, the video processor 110 may generate the output data by controlling the arrangement type of video frames constituting the content according to the type of the content.

The display 120 displays a plurality of content views. That is, the display 120 receives the output data constituted by the video processor 110 and alternately displays the plurality of content views.

In this case, the display 120 may have different driving frequencies according to the mode of the display apparatus 100 and the type of the content composed of the content views.

For example, if the output data generated by 2D content is output in a single-view mode, that is, in a mode in which one piece of content is displayed, the display 120 may output the respective video frames constituting the 2D content with a driving frequency of 60 Hz by outputting the output data with the driving frequency of 60 Hz. Further, if the output data generated by 3D content is output in a single-view mode, the display 120 may output left-eye video frames and right-eye video frames constituting the 3D content with a driving frequency of 60 Hz, respectively, by outputting the output data with a driving frequency of 120 Hz.

On the other hand, it is assumed that the present mode is a multi-view mode in which two content views are displayed. First, if the output data generated by the 2D content is output through each of the content views, the display 120 may output video frames constituting two 2D contents with a driving frequency of 60 Hz by outputting the output data with a driving frequency of 120 Hz. Further, if the output data generated by the 2D content and the 3D content is output through each of the content views, the display 120 may output video frames constituting the 2D content and left-eye and right-eye video frames constituting the 3D content with a driving frequency of 60 Hz by outputting the output data with a driving frequency of 180 Hz. Further, if the output data generated by the 3D content is output through each of the content views, the display 120 may output the left-eye and right-eye video frames constituting the 3D content with the driving frequency of 60 Hz by outputting the output data with the driving frequency of 240 Hz. However, this is merely exemplary, and the display 120 may output the video frames according to frequencies determined by particular products.

The synchronization signal generator 130 generates a synchronization signal for the plurality of content views. The synchronization signal may be generated in various ways according to wireless communication methods adopted between the display apparatus 100 and the glasses devices 200-1 and 200-2. For example, the synchronization signal may be generated in the form of an RF signal or an infra-red (IR) signal, or in the form of a data packet according to various kinds of wireless communication standards, such as, Bluetooth, Wi-Fi, ZigBee, and IEEE.

As described above, the synchronization signal may be implemented in various ways according to exemplary embodiments, and may include various kinds of information.

As an example, the synchronization signal may include a reference clock signal (e.g., frame sync) and synchronization information for notifying of the display timing of each content view based on the reference clock signal. The synchronization information is timing information for synchronizing the output timing of each content view with the shutter glasses driving timing, and may be composed of delay time information consumed from a specific point, for example, a rising edge or a falling edge, in the reference clock signal to the display time of each content view.

In addition, the synchronization signal may include various kinds of information according to exemplary embodiments. For example, the synchronization signal may include status information for notifying of whether a multi-view function is being executed or whether 3D content is being reproduced, and inherent information of the entire glasses devices that are paired to the display apparatus 100.

The communicator 140 transmits the synchronization signal. In this case, the communicator 140 may perform communication with the glasses devices according to various communication methods as described above. Hereinafter, explanation will be made on the basis of a case where the communicator 140 includes a Bluetooth communication module (not illustrated) and transmits the synchronization signal according to the Bluetooth method. That is, the communicator 140 may include the Bluetooth communication module (not illustrated) and may perform communication through performing the pairing operation with respect to the glasses devices.

The controller 150 controls the whole operation of the display apparatus 100. The controller 150 may include a microcomputer (or microcomputer and a Central Processing Unit (CPU), a Random Access Memory (RAM) for the operation of the display apparatus 100, and a ROM (Read Only Memory). In this case, these modules may be implemented in a System on Chip (SoC) type.

In particular, the controller 150 may control the communicator 140 to transmit information on the type of content that is provided in a multi-view mode to the glasses devices. Here, the information on the type of content may include information on whether the content provided in the multi-view mode is 2D content or 3D content.

That is, a user may select the type of the content that is provided from the content view synchronized with the user's glasses device through operating a button provided on the glasses device or the display apparatus 100. For example, the user may select 2D content or 3D content. In this case, the controller 150 may transmit the information on whether the content provided through each content view is 2D content or 3D content to the glasses device.

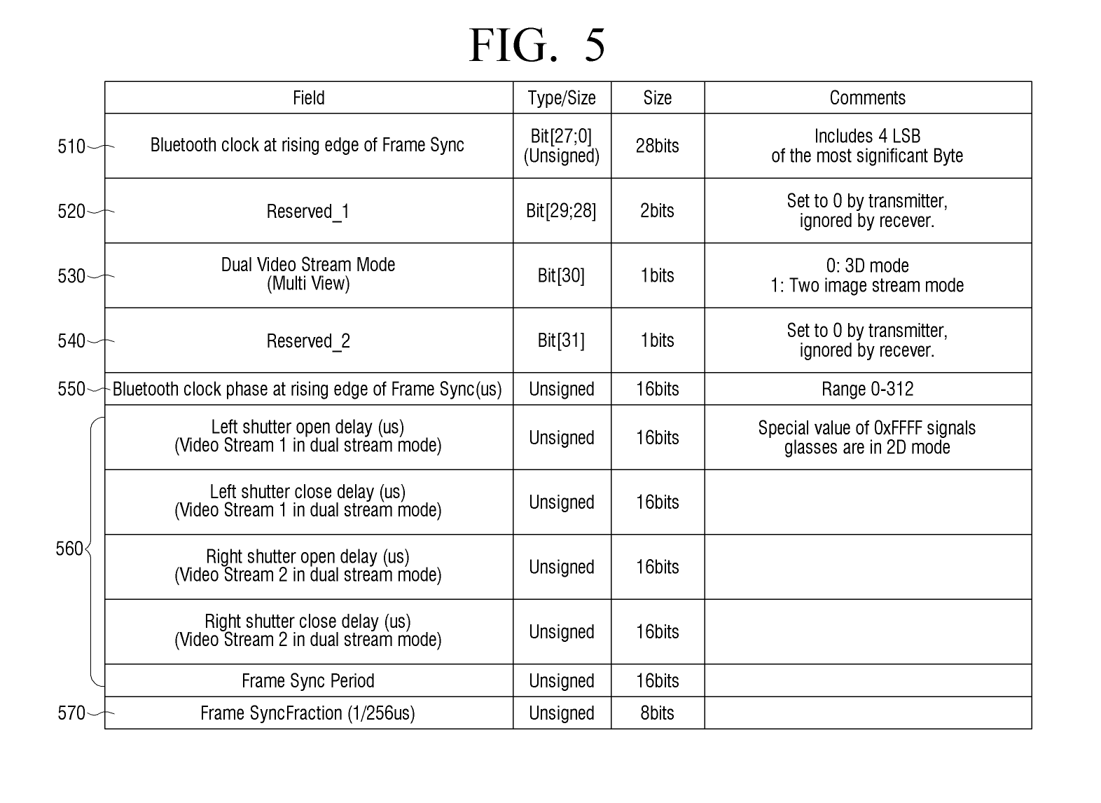

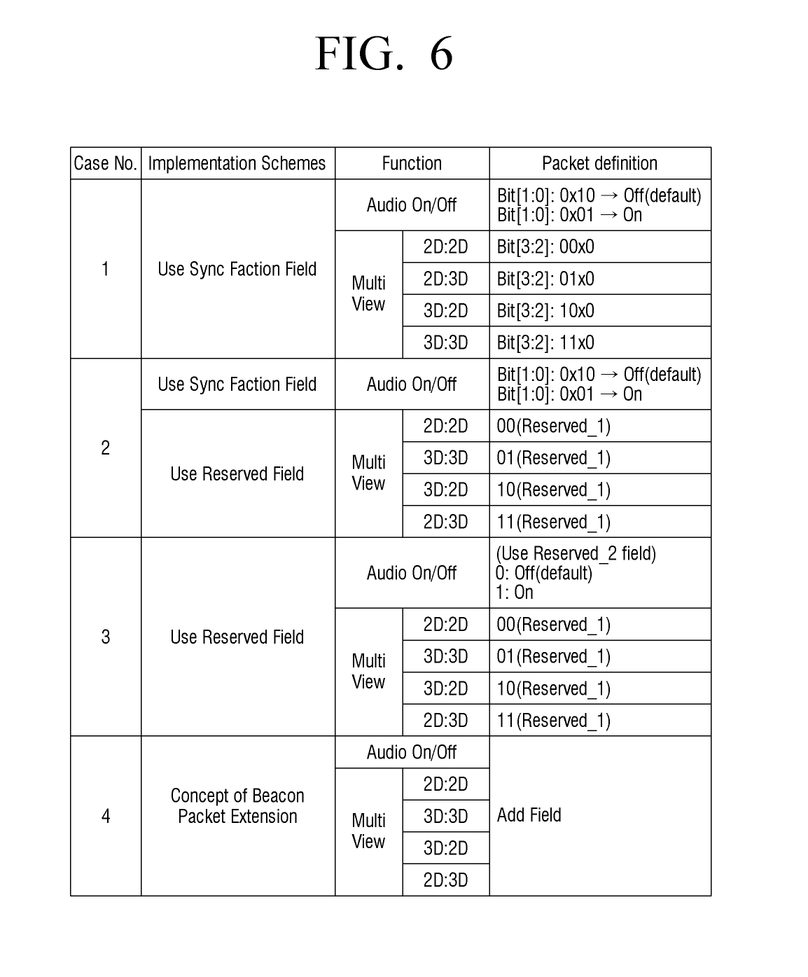

On the other hand, the information on the content type may be transmitted to the glasses device in various types. Hereinafter, referring to FIGS. 5 and 6, a method for transmitting the information on the content type to the glasses device, which is performed by the display apparatus 100, will be described.

First, FIG. 5 is a diagram explaining an example of a packet that a display apparatus transmits to a glasses device according to an exemplary embodiment.

Referring to FIG. 5, a payload region in the packet may include information 510, 550, and 570 related to a reference clock signal, information 530 on the type of content provided on a content view, delay time information 560 consumed from a specific point in the reference clock signal to the display time of each content view, and reserve regions 520 and 540.

Here, the information related to the reference clock signal may include a Bluetooth clock 510 at a rising edge of frame sync, a Bluetooth clock phase 550, and information 570 related to the frame sync, that is, information for inscribing a period of the frame sync if the period of the frame sync has a floating point.

The information 530 on the type of content provided on the content view may include information for indicating whether content provided on the content view is 2D content or 3D content.

Further, the delay time information 560 may include information on a delay time required for a glasses device to turn on left-eye shutter glasses according to the display timing of each content view, a delay time required to turn off the left-eye shutter glasses, a delay time required to turn on right-eye shutter glasses, and a delay time required to turn off the right-eye shutter glasses.

A packet that includes such information as described above may be called a beacon packet.

On the other hand, the controller 150 may add information on the type of content to a packet for transmission of the synchronization signal and transmit the packet having the information on the type of content added thereto to the glasses device. That is, the controller 150 may add the information on the type of content in addition to the information on the type of content existing in the beacon packet. This will be described in more detail with reference to FIG. 6.

FIG. 6 is a diagram illustrating an example of additional information on the type of content that is added to a packet for transmission of a synchronization signal when a display apparatus displays two contents according to an exemplary embodiment.

In this case, the display apparatus 100 may additionally add information on an audio state of content; that is, information on an on/off state, which is provided on a content view to transmit a packet having the information added thereto to a glasses device.

First, the controller 150 may transmit information on the type of content to the glasses device using a region of the packet in which information related to frame sync is included. For example, as shown in Case 1 of FIG. 6, the controller 150 may add information indicating whether content that is provided through a content view is 2D content or 3D content using two LSB bits in the region that includes the information related to the frame sync (i.e., sync fraction field). That is, if two 2D contents are displayed, the controller 150 may record a digital code 00x0, while if 2D content and 3D content are displayed, the controller 150 may record digital codes 01x0 and 10x0. If two 3D contents are displayed, the controller 150 may record a digital code 11x0.

Further, the controller 150 may additionally add information on the on/off state of audio of the content that is provided through the content view that is synchronized with the glasses device using two bits. That is, if the audio of the content is in an off state, the controller 150 may record a digital code 0x10, while if the audio of the content is in an on state, the controller 150 may record a digital code 0x01.

On the other hand, the controller 150 may add the information on the type of content using a reserve region provided in the packet to transmit the packet having the information on the type of content added thereto to the glasses device.

For example, as shown in Case 2 of FIG. 6, the controller 150 may add the information indicating whether the content that is provided through the content view is 2D content or 3D content using two bits in the reserve region. Here, the reserve region may be a reserve region 1 520 or a reserve region 2 540 as illustrated in FIG. 5.

Further, the controller 150 may add the information on the on/off state of the audio of the content that is provided through the content view synchronized with the glasses device to the region in which the information related to the frame sync is included using two bits.

As described above, the controller 150 may add the information on the type of content to the reserve region, and add the information on the audio state to the region in which the information related to the frame sync is included to transmit the packet having the above-described information added thereto.

On the other hand, the controller 150 may transmit the above-described information to the glasses device using only the reserve region provided in the packet. That is, as shown in Case 3 of FIG. 6, the controller 150 may add the information indicating whether the content provided through the content view is 2D content or 3D content to the reserve region 1 520 using two bits. Further, the controller 150 may further add the information on the on/off state of the audio of the content that is provided through the content view synchronized with the glasses device to the reserve region 2 540 using one bit. In this case, if the audio of the content is in the off state, the controller 150 may record a digital code 0, while if the audio of the content is in the on state, the controller 150 may record a digital code 1.

However, this is merely exemplary, and the controller 150 may add the information on the audio state to the reserve region 1 520 and add the information on the type of the content to the reserve region 2 540.

On the other hand, the controller 150 may add a new field to a packet for transmission with synchronization and transmit information on the type of content to the glasses device using the newly added field. That is, the controller 150 may generate a new field through extension of a beacon packet and add information on the type of content and information on the type of audio to the generated field to transmit the field to the glasses device. Even in this case, the respective information may be indicated through two bits. However, the information on the audio state may be indicated through one bit.

As described above, the display apparatus 100 can transmit the information on the type of content to the glasses device using the region in the packet for transmission of the synchronization signal, that is, the beacon packet.

In the above-described example, a rule for analyzing the digital codes that indicate the information on the type of the content and the information on the audio state may be predefined between the display apparatus 100 and the glasses devices.

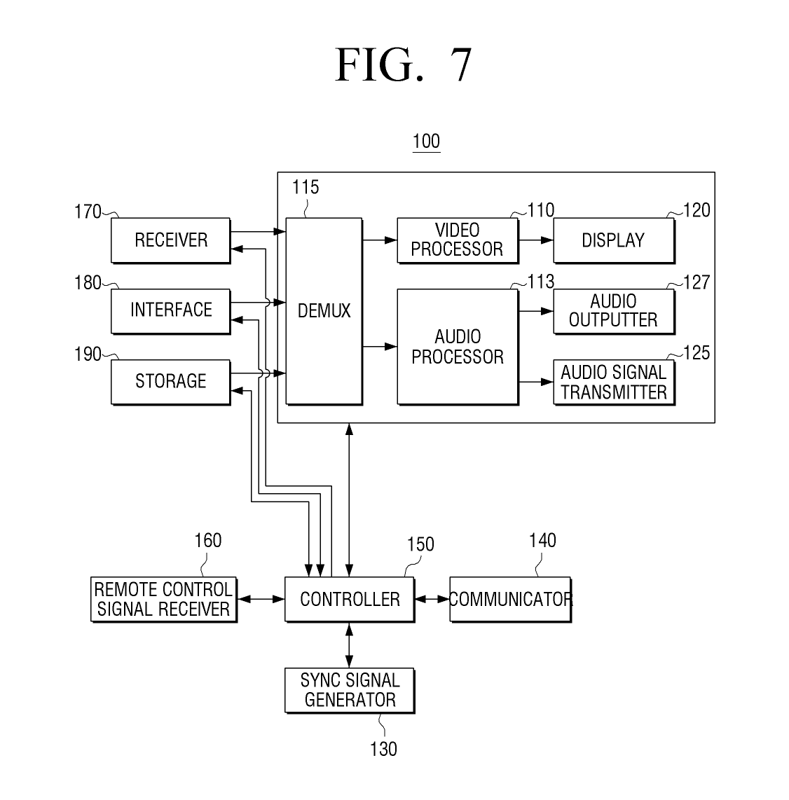

FIG. 7 is a block diagram illustrating the detailed configuration of a display apparatus according to an exemplary embodiment. Referring to FIG. 7, a display apparatus 100 may include a video processor 110, a display 120, a synchronization signal generator 130, a communicator 140, a controller 150, an audio processor 113, a DEMUX 115, an audio signal transmitter 125, an audio outputter 127, a remote control signal receiver 160, a receiver 170, an interface 180, and a storage 190. The above-described constituent elements may be controlled by the controller 150. In explaining the configuration illustrated in FIG. 7, the detailed explanation of the same constituent elements as the constituent elements illustrated in FIG. 4 will be omitted.

The remote control signal receiver 160 receives a remote control signal from a remote controller. The remote control signal may be transmitted according to various communication methods. As an example, the remote control signal may be composed of a code signal in which a read code, a custom code, and a data code are combined, and may be transmitted using a carrier frequency signal included in a frequency band that is determined for each manufacturer or product.

The controller 150 performs various operations according to the remote control signal received through the remote control signal receiver 160. As an example, if a turn-on command is input, the controller 150 may turn on the respective constituent elements in the display apparatus 100 by supplying a power to the constituent elements. Further, if a channel switching command or a volume control command is input, the controller 150 may perform a corresponding channel switching operation or volume control operation. Although FIG. 7 illustrates only the remote control signal receiver 160, the controller 150 may perform various control operations even according to user commands input through an input means, such as various kinds of buttons provided on the display apparatus 100.

The receiver 170 is a configuration to receive broadcasting program content through a broadcasting network. The receiver 170 may include a tuner selecting a broadcasting channel, a demodulator demodulating a broadcasting signal that is received through the selected broadcasting channel, and an equalizer equalizing the demodulated broadcasting signal. The receiver 170 may be implemented in various types according to the broadcasting standards adopted in countries in which the display apparatuses 100 are used. Further, although FIG. 7 illustrates only one receiver 170, a plurality of receivers 170 may be implemented. That is, in the case of performing a multi-view function using a plurality of broadcasting programs, the controller 150 may control the plurality of receivers 170 to select different broadcasting channels and to configure and output a plurality of content views using the broadcasting signals received through the selected broadcasting channels.

The interface 180 is a configuration that receives content transmitted through the Internet or other local networks. Particularly, in order to receive content by accessing a web server through the Internet, the interface 180 may be implemented by a network interface card.

The storage 190 is a configuration that stores various kinds of content. The storage 190 may store a recorded file of a broadcasting signal that is received through the receiver 170, and may store content that is streamed or downloaded through the interface 180. In addition, the storage 190 may store an O/S or other programs for driving the display apparatus 100 and various kinds of set values that are set by a user to use the display apparatus 100.

The controller 150 controls the whole operation of the display apparatus 100. The display apparatus 100 may support a multi-view mode. If the multi-view mode is performed, the controller 150 may acquire a plurality of contents using the receiver 170, the interface 180, and the storage 190. Although not illustrated in FIG. 7, the display apparatus 100 may further include reproduction devices reproducing various external recording media mounted thereon. For example, if various types of recording media, such as a compact disk (CD), a digital versatile disk (DVD), a Blu-ray disk, a memory card, and a universal serial bus (USB) memory, are mounted, the reproduction means included in the display apparatus 100 may read data stored in the recording media.

The DEMUX 115 separates audio data and video data from the content that is acquired through various means, such as the receiver 170, the interface 180, and the storage 190. The separated video data is provided to the video processor 110, and the separated audio data is provided to the audio processor 113.

The video processor 110 performs decoding of video data provided thereto, performs scaling of the decoded video data to match a screen size, and then converts a frame rate to match an output rate. If the multi-view mode starts, the video processor 110 generates respective video frames using video data of different contents, and then generates output video data through connection of the generated video frames in a top-to-bottom format or in a side-by-side format.

The display 120 alternately displays a plurality of content views on the screen using the output video data generated by the video processor 110. The display 120 may be implemented by a light-emitting diode (LED) display that includes a display panel (not illustrated) and a backlight unit (not illustrated), and may also be implemented by a display of an organic light-emitting diode (OLED) type, a plasma display panel (PDP) type, or any other type.

The audio processor 113 performs various processes, such as decoding, noise filtering, and amplification, with respect to audio data provided from the DEMUX 115. The audio processor 113 provides the processed audio data to the audio outputter 127 or the audio signal transmitter 125. The audio outputter 127 is a configuration that outputs an audio signal, such as a speaker, and the audio signal transmitter 125 is a configuration that modulates and transmits the audio signal to the glasses device.

The audio signal transmitter 125 includes an RF communication module. The audio signal transmitter 125 may transmit the audio signal that corresponds to the content provided through each content view to the glasses device.

On the other hand, if the multi-view mode is executed, the controller 150 controls the video processor 110 and the display 120 to generate and display a plurality of content views. Further, the controller 150 may transmit a synchronization signal for synchronization between each content view and the glasses device to each glasses device. Here, the glasses device may be a glasses device of which the pairing operation with the communicator 140 has been completed.

For example, it is assumed that the multi-view mode is executed, and two glasses devices successively perform the pairing operation with the display apparatus 100. In this case, if broadcasting channel no. 7 is selected as a source of content view 1 and broadcasting channel no. 11 is selected as a source of content view 2, the controller 150 may operate to alternately display respective video frames of 2D broadcasting content provided through the broadcasting channel no. 7 and left-eye and right-eye video frames of 3D broadcasting content provided through the broadcasting channel no. 11.

Then, the controller 150 may control the respective glasses devices to be synchronized with the respective content views.

That is, the controller 150 may transmit the synchronization signal for synchronizing the display timing of the content view 1 with glasses device 1, to the glasses device 1. Here, the synchronization signal may include delay time information for turning on both left-eye shutter glasses and right-eye shutter glasses in the display timing of the video frame on the content view 1 and delay time information for turning off both the left-eye shutter glasses and the right-eye shutter glasses in the timing when the display of the video frame on the content view 1 is ended.

In the same manner, the controller 150 may transmit the synchronization signal for synchronizing the display timing of the content view 2 with glasses device 2, to the glasses device 2. Here, the synchronization signal may include delay time information for turning on the left-eye shutter glasses in the display timing of the left-eye video frame on the content view 2, delay time information for turning off the left-eye shutter glasses in the timing when the display of the left-eye video frame is ended, delay time information for turning on the right-eye shutter glasses in the display timing of the right-eye video frame on the content view 2, and delay time information for turning off the right-eye shutter glasses in the timing when the display of the right-eye video frame is ended.

Then, the controller 150 may control the audio signal transmitter 125 to transmit the audio signal that corresponds to each content view to the glasses device. Specifically, the controller 150 may operate to modulate the audio signal into a carrier frequency signal included in a predefined frequency band and to transmit the modulated carrier frequency signal. In this case, the predefined frequency band may differ according to each content view.

In the above-described example, the controller 150 may modulate the audio signal of 2D content provided through broadcasting channel no. 7 into the carrier frequency signal of the frequency band predefined with respect to the content view 2 and transmit the modulated carrier frequency signal to the glasses device 2.

Further, the controller 150 may transmit information on the type of displayed content on each content view.

In the above-described example, in the case that the 2D content is displayed through the content view 1 and the 3D content is displayed through the content view 2, the controller 150 may add a digital code 01x0 to a region where information related to the frame sync is provided to transmit the information to the glasses device 1, and may add a digital code 10x0 to a region where information related to the frame sync is provided to transmit the information to the glasses device 2. Accordingly, it may be determined that the glasses device 1 displays the 2D content on the content view that is synchronized with the glasses device 1 itself, and displays the 3D content on the content view that is synchronized with the other glasses device. In the same manner, it may be determined that the glasses device 2 displays the 3D content on the content view that is synchronized with the glasses device 2 itself, and displays the 2D content on the content view that is synchronized with the other glasses device.

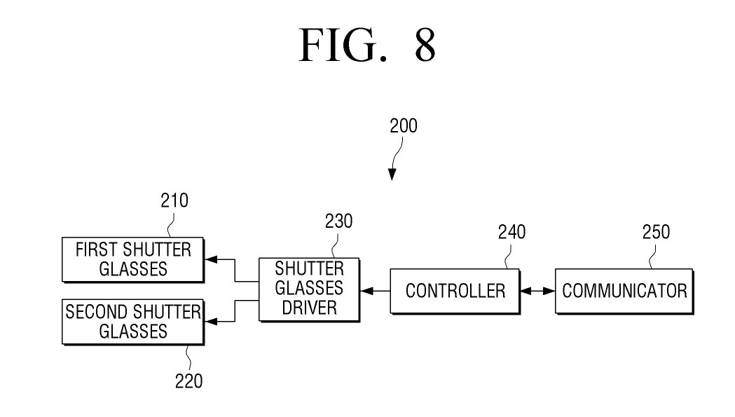

FIG. 8 is a block diagram illustrating the configuration of a glasses device according to an exemplary embodiment. Referring to FIG. 8, a glasses device 200 includes first and second shutter glasses 210 and 220, a shutter glasses driver 230, a controller 240, and a communicator 250.

Each of the first and second shutter glasses 210 and 220 may include a plurality of transparent electrodes, a liquid crystal layer arranged between the transparent electrodes, a polarizing plate, and a transparent substrate supporting the above-described constituent elements. Accordingly, respective liquid crystals of the liquid crystal layer are turned on or off according to voltages applied to the plurality of transparent electrodes. In a turn-off state, light permeation is intercepted, and in a turn-on state, light permeation is performed like general glasses.

The shutter glasses driver 230 includes a driving circuit connected to the transparent electrodes provided on the first and second shutter glasses 210 and 220. The shutter glasses driver 230 individually drives the first and second shutter glasses 210 and 220 by applying a driving signal to the transparent electrodes provided on the first and second shutter glasses 210 and 220. The shutter glass driver 230 collectively turns on or off the first and second shutter glasses 210 and 220 while the 2D content is reproduced, and alternately turns on or off the first and second shutter glasses 210 and 220 one by one while the 3D content is reproduced.

If the communication connection with the display apparatus 100 starts, the communicator 250 receives various signals from the display apparatus 100. Specifically, the communicator 250 may receive the synchronization signal for synchronization with each content view displayed through the display apparatus 100.

The controller 240 controls the whole operation of the glasses device 200.

First, the controller 240 may control the shutter glasses driver 230 to operate the first and second shutter glasses 210 and 220 according to the synchronization signal received from the display apparatus 100.

Specifically, the controller 240 may turn on or off the first and second shutter glasses 210 and 220 at a time that is delayed as long as the delay time from a specific point of a reference clock signal, using the reference clock signal and the delay time information included in the synchronization signal.

For example, if the glasses device 200 is synchronized with the content view 1 that is displayed through the display apparatus 100 and the 2D content is displayed through the content view 1, the controller 240 may turn on both the first and second shutter glasses 210 and 220 for a first delay time from the specific point of the reference clock signal, and may turn off both the first and second shutter glasses 210 and 220 for a second delay time from the time that is delayed for the first delay time.

As another example, if the 3D content is displayed through the content view 1, the controller 240 may turn on the first shutter glasses 210 and turn on the second shutter glasses 220 for the first delay time from the specific point of the reference clock signal, and may turn off the first shutter glasses 210 and turn on the second shutter glasses 220 for the second delay time from the time that is delayed for the first delay time.

On the other hand, the controller 240 may determine the type of content that is displayed through the content view synchronized with the glasses device 200. That is, the controller may determine whether the 2D content or the 3D content is displayed through the content view synchronized with the controller 240.

Specifically, the controller 240 may determine the type of content that is displayed through the content view synchronized with the controller 240 through analysis of the digital codes that are recorded in the region in which information related to the frame sync is included or the reserve region in the packet for transmission of the synchronization signal. For example, the controller 150 may determine that the 2D content is displayed if the digital code read from the region in which the information related to the frame sync is included is 00x0 or 01x0, and may determine that the 3D content is displayed if the read digital code is 10x0 or 11x0. Accordingly, if the multi-view mode is executed in the display apparatus 100, the controller 240 may operate to drive the first and second shutter glasses 210 and 220 to match the type of the content view that is synchronized with the controller 210.

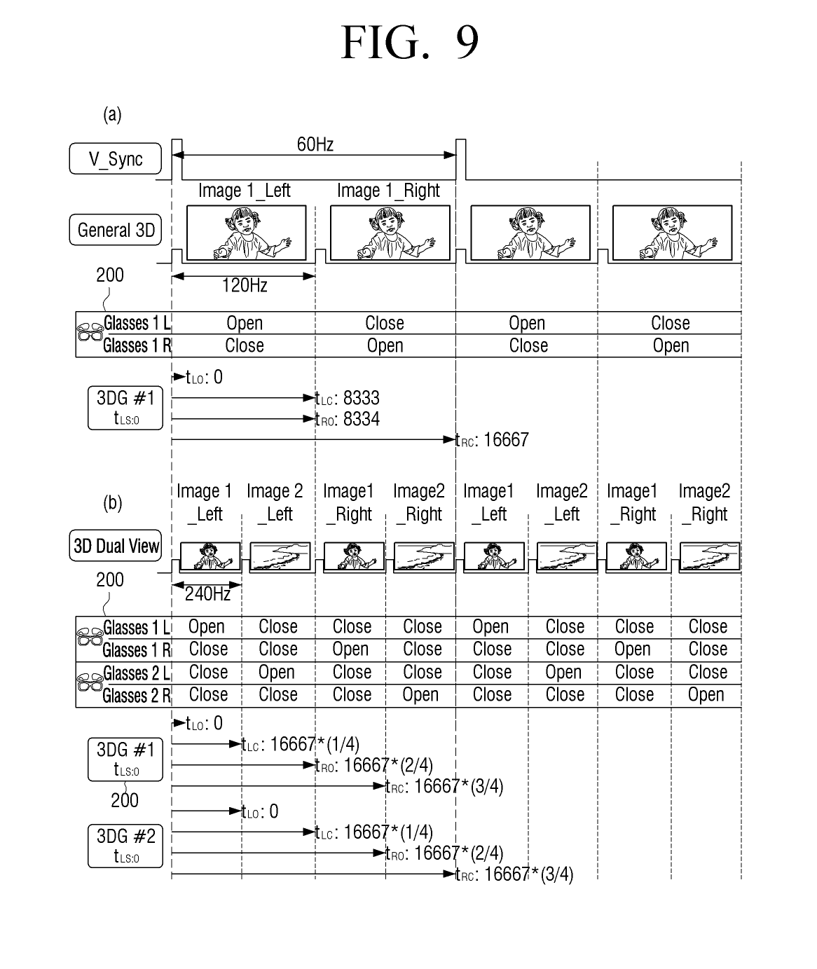

On the other hand, the controller 240 may determine the type of content that is displayed on the content view that is synchronized with the controller 240 using another method that is not related to the digital code transmitted from the display apparatus 100. This will be described in more detail with reference to FIG. 9.

FIG. 9 is a diagram explaining a method for determining the type of content that is displayed through a content view synchronized with a glasses device according to an exemplary embodiment. In FIG. 9, it is assumed that first shutter glasses 210 are left-eye shutter glasses, and second shutter glasses 220 are right-eye shutter glasses.

First, (a) of FIG. 9 illustrates a case where 3D content is displayed through a content view in a single-view mode. As shown as (a) of FIG. 9, in the case where the 3D content is displayed in the single-view mode, the display apparatus 100 transmits a synchronization signal for synchronizing the left-eye shutter glasses 210 and the right-eye shutter glasses 220 provided in glasses device 1 200 to the glasses device 1 200 based on the timing when the left-eye video frame and the right-eye video frame, which constitute the 3D content, are displayed.

Specifically, the synchronization signal includes a frame sync signal of 60 Hz, a delay time tL0 for turning on the left-eye shutter glasses 210 from a rising edge of the frame sync signal, a delay time tLC for turning off the left-eye shutter glasses 210, a delay time tR0 for turning on the right-eye shutter glasses 220, and a delay time tRC for turning off the right-eye shutter glasses 220. Accordingly, the controller 240 operates to turn on the left-eye shutter glasses 210 from the rising edge of the frame sync signal to the time point where 8333 μs delayed and to turn on the right-eye shutter glasses 220 from the time point where 8334 μs delayed from the rising edge to the time point where 16667 μs delayed.

On the other hand, as shown in (b) of FIG. 9, if the multi-view mode is executed, the display apparatus 100 transmits a synchronization signal for synchronizing the 3D content that is displayed through the content view synchronized with the glasses device 1 200, to the glasses device 1 200.

Specifically, the synchronization signal includes a frame sync signal of 120 Hz, a delay time tL0 for turning on the left-eye shutter glasses 210 from the rising edge of the frame sync signal, a delay time tLC for turning off the left-eye shutter glasses 210, a delay time tR0 for turning on the right-eye shutter glasses 220, and a delay time tRC for turning off the right-eye shutter glasses 220. Accordingly, the controller 240 turns on the left-eye shutter glasses 210 from the rising edge of the frame sync signal to the time point where 16667*(¼) μs delayed, and turns on the right-eye shutter glasses 220 from the time point where 16667*( 2/4) μs us delayed to the time point where 16667*(¾) μs delayed.

On the other hand, in the case where the 3D content is displayed in the multi-view mode, the duty ratio of the delay time for driving the respective shutter glasses based on the time when the 3D content is displayed in the single-view mode becomes 50%, and the frame sync signal is changed from 60 Hz to 120 Hz. Further, if the multi-view mode is executed, the display apparatus 100 may add information indicating that the multi-view mode is executed (e.g., digital code 1 of 530 in FIG. 5) to the packet for transmission of the synchronization signal to transmit the packet to the glasses device 1 200.

Accordingly, the controller 240 may determine that the 3D content is displayed through the content view synchronized with the controller 240 using the duty ratio, the period of the frame sync signal, and the information indicating that the multi-view mode is executed.

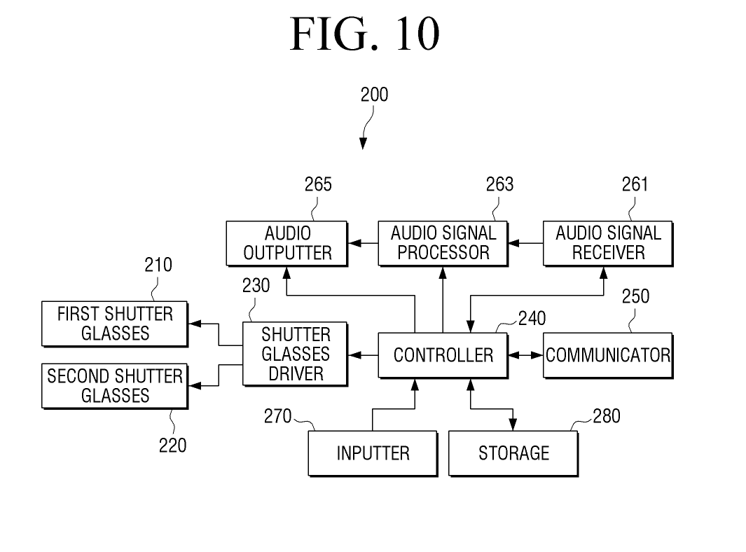

FIG. 10 is a block diagram illustrating the detailed configuration of a glasses device according to an exemplary embodiment. Referring to FIG. 10, a glasses device 200 includes first shutter glasses 210, second shutter glasses 220, a shutter glasses driver 230, a controller 240, a communicator 250, an audio signal receiver 261, an audio signal processor 263, an audio outputter 265, an inputter 270, and a storage 280. The above-described constituent elements may also be controlled by the controller 240. In explaining the configuration illustrated in FIG. 10, the detailed explanation of the same constituent elements as the constituent elements illustrated in FIG. 9 will be omitted.

The inputter 270 includes various kinds of keys provided for a user to control the operation of the glasses device 200. Specifically, a power key, a pairing key, a content view switching key, and a volume control key may be provided in the inputter 270. These keys may be implemented in various types, such as a push button, a dial, a jog-shuttle, a wheel, and a touch pad.

The controller 240 may perform various control operations according to the operation state of the various kinds of keys provided in the inputter 270. For example, if the power key is selected in a turn-off state, the controller 240 performs the turn-on operation by reopening the power supply from a battery (not illustrated) to the respective constituent elements, and if the power key is selected in a turn-on state, the controller 240 intercepts the power supply using a switch (not illustrated).

Further, if a pairing key for performing a pairing operation with respect to the display apparatus 100 is selected, the controller 240 performs the pairing operation by controlling the communicator 250. Specifically, the controller 240 controls the communicator 250 to transmit a pairing trigger signal to the display apparatus. Thereafter, if address information of the display apparatus is received through the communicator 250, the controller 240 stores the address information in the storage 280. The communicator 250 performs communication connection with the display apparatus 100 using the stored address information. The communicator 250 may use the address information that is acquired in the pairing process during communication reconnection. That is, if the power of the display apparatus is turned off and then is turned on while the glasses device 200 is connected to communicate with the display apparatus 100, the controller 240 controls the communicator 250 to perform communication reconnection with the display apparatus using the address information stored in the storage 280.

The storage 280 may store various kinds of data, such as synchronization signals received through the communicator 250 in addition to the address information received from the display apparatus 100. Further, the storage 280 may store various kinds of driving programs for driving the glasses devices.

The audio signal receiver 261 receives an audio signal that corresponds to the content view synchronized with the glasses device 200 among a plurality of audio signals output from the display apparatus 100. As described above, if the multi-view function is performed, the display apparatus 100 may detect audio data of the respective contents and output the detected audio data through different wireless frequency channels. The audio signal receiver 261 receives the audio signal by selecting a wireless frequency channel using wireless frequency channel information that corresponds to the content view selected by the controller 240. The wireless frequency channel information may be transmitted from the display apparatus 100 or may be pre-stored in the storage 280.

The audio signal processor 263 detects the audio data by processing the audio signal received from the audio signal receiver 261. Specifically, the audio signal processor 263 may perform processes, such as demodulation, noise filtering, and amplification.

The audio outputter 265 outputs the audio data that is processed by the audio signal processor 263. The audio outputter 265 may be implemented in the form of a speaker or an earphone. When the audio data is output, the audio outputter 265 may output the audio data with a predetermined volume level. The volume control may be performed using a variable resistor provided at an output terminal. That is, if a volume control key provided on the inputter 270 is operated, the audio outputter 265 may change the volume level of the output audio signal by changing the variable resistance value according to the operation state.

If a volume control command is input through the inputter 270, the controller 240 controls the audio outputter 265 to control the volume of the audio data according to the volume control command. In this state, if a turn-off command for turning off the glasses device is input through the inputter 270, the controller 240 stores the finally controlled volume information in the storage 280. Then, the controller 240 performs the turn-off operation.

Thereafter, if a turn-on command for turning on the glasses device is input through the inputter 270, the controller 240 controls the communicator 250 to reconnect the communication with the display apparatus 100. In addition, the controller 240 controls the audio outputter 265 to control the output volume of the audio data based on the volume information stored in the storage 280. As a result, when the communication is reconnected, the glasses device 200 can directly output the audio signal with the previously set volume level.

In contrast, if the pairing operation with the display apparatus 100 is performed, the controller 240 may control the audio outputter 265 to control an initial volume of the audio data according to the volume level that is set as a default value in the display apparatus.

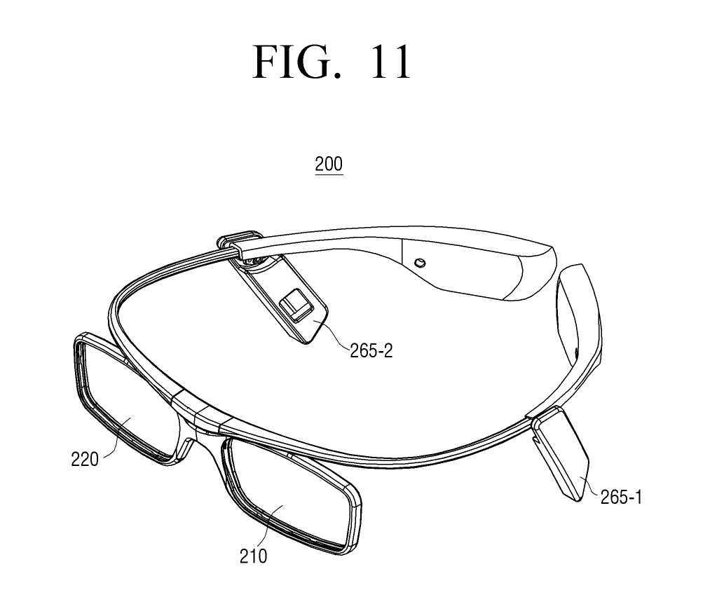

FIG. 11 is a view illustrating an example of an external appearance of a glasses device according to an exemplary embodiment. Referring to FIG. 11, the glasses device 200 includes a glasses frame supporting a plurality of shutter glasses 210 and 220, and a plurality of audio outputters 265-1 and 265-2 arranged in the vicinity of both ears.

Although FIG. 11 illustrates that the first and second shutter glasses 210 and 220 are in a rectangular shape, they may have different shapes, such as a circle or an ellipse. Although FIG. 11 illustrates that the audio outputters 265-1 and 265-2 are implemented in the form of a speaker, the audio outputters 265-1 and 265-2 may also be implemented in the form of an earphone.

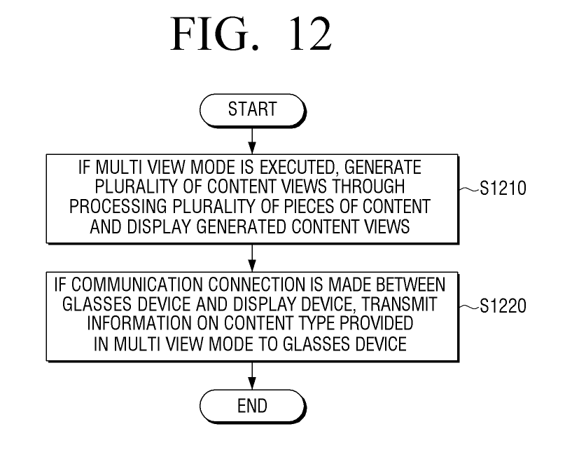

FIG. 12 is a diagram illustrating a method for controlling a display apparatus according to an exemplary embodiment.

First, if a multi-view mode is executed, a plurality of content views are generated through processing of a plurality of contents, and the generated content views are displayed (S1210).

Then, if communication connection between a glasses device and a display apparatus is performed, information on the type of content that is provided in the multi-view mode is transmitted to the glasses device (S1220). Here, the information on the type of content includes information indicating whether content that is provided in the multi-view mode is 2D content or 3D content.

In S1220, the information on the type of content may be added to a packet for transmission of a synchronization signal to transmit the packet to the glasses device.

Specifically, the information on the type of content may be added using a reserve region provided in the packet for transmission of the synchronization signal to transmit the packet to the glasses device. Further, the information on the type of content may be transmitted to the glasses device using a region in which information related to frame sync is included in the packet for transmission of the synchronization signal. Further, a new field may be added to the packet for transmission of the synchronization signal, and the information on the type of content may be transmitted to the glasses device using the newly added field.

As described above, the display apparatus may provide a plurality of contents in various methods. A method for controlling a display apparatus according to the various exemplary embodiments as described above may be generated as software and mounted on the display apparatus.

Specifically, according to an exemplary embodiment, a program for performing a method for controlling a display apparatus including processing a plurality of contents and generating a plurality of content views to display the generated content views if a multi-view mode is executed, and transmitting information on a type of the content provided in the multi-view mode to a glasses device if a communication connection is made between the glasses device and the display apparatus, may be stored in a non-transitory computer readable medium provided in the display apparatus.

The non-transitory computer readable medium is not a medium that stores data for a short period, such as a register, a cache, or a memory, but means a medium which semi-permanently stores data and is readable by a device. Specifically, various applications and programs as described above may be stored and provided in the non-transitory computer readable medium, such as a CD, a DVD, a hard disc, a Blu-ray disc, a USB, a memory card, or a ROM.

While the present disclosure has been shown and described with reference to certain exemplary embodiments thereof, it will be understood by those skilled in the art that various changes in form and detail may be made therein without departing from the spirit and scope of the present disclosure, as defined by the appended claims.

What is claimed is:

1. A display apparatus providing a multi-view mode in association with at least one glasses device, comprising:
a video processor configured to process a plurality of contents and generate a plurality of content views if the multi-view mode is executed;
a display configured to display the plurality of content views;
a synchronization signal generator configured to generate a synchronization signal for the plurality of content views;
a communicator configured to transmit the synchronization signal; and
a controller configured to control the communicator to transmit information on a type of the content provided in the multi-view mode to the at least one glasses device.

2. The display apparatus as claimed in claim 1, wherein the information on the type of the content includes information indicating whether the content provided in the multi-view mode is 2D content or 3D content.

3. The display apparatus as claimed in claim 1, wherein the controller adds the information on the type of the content to a packet for transmission of the synchronization signal, to transmit the packet to the at least one glasses device.

4. The display apparatus as claimed in claim 3, wherein the controller adds the information on the type of the content to the packet for transmission of the synchronization signal using a reserve region provided in the packet to transmit the packet to the at least one glasses device.

5. The display apparatus as claimed in claim 3, wherein the controller adds the information on the type of the content to the packet for transmission of the synchronization signal using a region provided in the packet and including information related to frame synchronization to transmit the packet to the at least one glasses device.

6. The display apparatus as claimed in claim 3, wherein the controller adds a new field to the packet for transmission of the synchronization signal and transmits the information on the type of the content to the at least one glasses device using the new field.

7. A method for controlling a display device providing a multi-view mode, comprising:
processing a plurality of contents and generating a plurality of content views to display the generated content views if the multi-view mode is executed; and
transmitting information on a type of the content provided in the multi-view mode to at least one glasses device if a communication connection is made between the at least one glasses device and the display apparatus.

8. The method as claimed in claim 7, wherein the information on the type of the content includes information indicating whether the content provided in the multi-view mode is 2D content or 3D content.

9. The method as claimed in claim 7, wherein the transmitting comprises adding the information on the type of the content to a packet for transmission of the synchronization signal, to transmit the packet to the at least one glasses device.

10. The method as claimed in claim 9, wherein the transmitting comprises adding the information on the type of the content to the packet for transmission of the synchronization signal using a reserve region provided in the packet, to transmit the packet to the at least one glasses device.

11. The method as claimed in claim 9, wherein the transmitting comprises adding the information on the type of the content to the packet for transmission of the synchronization signal using a region provided in the packet and including information related to frame synchronization to transmit the packet to the at least one glasses device.

12. The method as claimed in claim 9, wherein the transmitting comprises adding a new field to the packet for transmission of the synchronization signal and transmits the information on the type of the content to the at least one glasses device using the new field.

13. A system for providing a multiview mode, the system comprising:
a display apparatus; and
at least one glasses device,
wherein the display apparatus comprises:
a video processor configured to process a plurality of contents and generate a plurality of content views if the multi-view mode is executed;
a display configured to display the plurality of content views;
a synchronization signal generator configured to generate a synchronization signal for the plurality of content views;
a communicator configured to transmit the synchronization signal; and
a controller configured to control the communicator to transmit information on a type of the content provided in the multi-view mode to the at least one glasses device.

14. The system as claimed in claim 13, wherein the information on the type of the content includes information indicating whether the content provided in the multi-view mode is 2D content or 3D content.

15. The system as claimed in claim 13, wherein the controller adds the information on the type of the content to a packet for transmission of the synchronization signal, to transmit the packet to the at least one glasses device.

16. The system as claimed in claim 15, wherein the controller adds the information on the type of the content to the packet for transmission of the synchronization signal using a reserve region provided in the packet to transmit the packet to the at least one glasses device.

17. The system as claimed in claim 15, wherein the controller adds the information on the type of the content to the packet for transmission of the synchronization signal using a region provided in the packet and including information related to frame synchronization to transmit the packet to the at least one glasses device.

18. The system as claimed in claim 15, wherein the controller adds a new field to the packet for transmission of the synchronization signal and transmits the information on the type of the content to the at least one glasses device using the new field.
